(19) United States
(12) Patent Application Publication
(10) Pub. No.: US 2018/0189083 A1
(43) Pub. Date: Jul. 5, 2018

(54) METHOD AND DEVICE FOR OPERATING TARGET APPLICATION ON CORRESPONDING EQUIPMENT

(71) Applicant: BAIDU ONLINE NETWORK TECHNOLOGY (BEIJING) CO., LTD., Beijing (CN)

(72) Inventors: Meng LIU, Beijing (CN); Jun LI, Beijing (CN); Daolong WANG, Beijing (CN); Xiaowei LIU, Beijing (CN); Huaming LI, Beijing (CN); Yi YUAN, Beijing (CN); Yu ZHANG, Beijing (CN); Yufei YAN, Beijing (CN); Minwen YI, Beijing (CN); Wenyu LV, Beijing (CN)

(73) Assignee: BAIDU ONLINE NETWORK TECHNOLOGY (BEIJING) CO., LTD ., Beijing (CN)

(21) Appl. No.: 15/301,361

(22) PCT Filed: Oct. 27, 2015
(86) PCT No.: PCT/CN2015/092880

§ 371 Date: Feb. 16, 2018

(30) Foreign Application Priority Data
Feb. 3, 2015 (CN) 201510056807.1

(51) Int. Cl. G06F 9/451; G06F 9/54

(52) U.S. Cl. CPC G06F 9/452; G06F 9/547; G06F 9/541

(57) ABSTRACT

An objective of the present application provides a method and apparatus for operating a target application on a corresponding device. Specifically, the first user equipment receives a desktop screenshot sent by the second user equipment, displays the desktop screenshot; in response to a corresponding user's select operation on the application identification information in the desktop screenshot, converts coordinates of the application identification information on the first user equipment's screen to coordinates of the application identification information on the second user equipment's screen; sends coordinates of the application identification information on the second user equipment's screen to the second user equipment; receives an application screenshot of the started target application sent from the second user equipment; and displays the application screenshot. Compared with the prior art, the present application implements a simple static picture transmission between two user equipments, and then, through a coordinate mapping method, the user may freely use an application on another user equipment in one user equipment. This enhances the user's experience in using the app and also reduces the development cost of the app.

### CROSS REFERENCE OF RELATED APPLICATION

The present application claims the priority of Chinese Patent Application No. 201510056807.1, filed on Feb. 3, 2015, entitled “Method and Apparatus for Operating a Target Application on a Corresponding Device”, the contents of which is incorporated herein by reference in its entirety.

### FIELD OF THE APPLICATION

The present application relates to the field of Internet technologies, and more specifically, to a technology of operating a target application on a corresponding device.

### BACKGROUND OF THE APPLICATION

Now, terminals available for users become more and more, while these terminals may use different operating systems, e.g., Windows, Linux, Mac OS, iOS, Android, Windows Phone, etc. Terminals with different operating systems may install a plurality of apps (applications) to enrich function of the terminals so as to support user requirements. However, in the prior art, an app which is suitable for a certain operating system cannot be used on a terminal with another operating system, such that apps which are suitable for different operating systems cannot be cross platform, which decreases the portability of apps; meanwhile, in order to satisfy requirements of different terminals, a developer has to develop various versions of apps adapted to different terminals, e.g., developing a Windows version app, a Windows phone version app, an iPhone version app, an iPad version app, and an Android version app, etc., which increases the development cost. Moreover, when a user uses a certain terminal, he/she can only use an app supported by the terminal, but cannot use apps in the terminal with other operating system. Apparently, this affects the user's experience of using the app and equipment.

### SUMMARY OF THE APPLICATION

An objective of the present application is to provide a method and apparatus for operating a target application on a corresponding device.

According to an aspect of the present application, there is provided a method, at a first user equipment, for operating a target application on a second user equipment corresponding to the first user equipment, wherein the method comprises:
receiving a desktop screenshot sent by the second user equipment, wherein the desktop screenshot includes application identification information of a target application displayed on the second user equipment's desktop;
displaying the desktop screenshot;
in response to a corresponding user's select operation on the application identification information in the desktop screenshot, converting coordinates of the application identification information on the first user equipment's screen into coordinates of the application identification information on the second user equipment's screen;
sending coordinates of the application identification information on the second user equipment's screen to the second user equipment;
receiving an application screenshot of the started target application sent by the second user equipment; and
displaying the application screenshot.

According to another aspect of the present application, there is provided a method, at a second user equipment, for assisting a first user equipment to operate a target application on the second user equipment, wherein the method comprises:
sending a desktop screenshot to a corresponding first user equipment, wherein the desktop screenshot includes application identification information of the target application displayed on the second user equipment's desktop;
receiving coordinates of the application identification information on the second user equipment's screen sent by the first user equipment;
performing a start application operation at the coordinates to start the target application;
sending an application screenshot of the started target application to the first user equipment.

According to an aspect of the present application, there is further provided a first user equipment for operating a target application on a second user equipment corresponding to the first user equipment, wherein the first user equipment comprises:
a unit configured to receive a desktop screenshot sent by the second user equipment, wherein the desktop screenshot includes application identification information of a target application displayed on the second user equipment's desktop;
a unit configured to display the desktop screenshot;
a unit configured to, in response to a corresponding user's select operation on the application identification information in the desktop screenshot, convert coordinates of the application identification information on the first user equipment's screen into coordinates of the application identification information on the second user equipment's screen;
a unit configured to send coordinates of the application identification information on the second user equipment's screen to the second user equipment;
a unit configured to receive an application screenshot of the started target application sent by the second user equipment; and
a unit configured to display the application screenshot.

According to another aspect of the present application, there is provided a second user equipment for assisting a first user equipment to operate a target application on the second user equipment, wherein the second user equipment comprises:
a unit configured to send a desktop screenshot to a corresponding first user equipment, wherein the desktop screenshot includes application identification information of a target application displayed on the second user equipment's desktop;
a unit configured to receive coordinates of the application identification information on the second user equipment's screen sent by the first user equipment;
a unit configured to perform a start application operation at the coordinates to start the target application;
a unit configured to send an application screenshot of the started target application to the first user equipment.

According to a further aspect of the present application, there is further provided a system for operating a target application on a corresponding device, wherein the system comprises a first user equipment for operating a target application on a corresponding second user equipment according to one aspect of the present application, and a second user equipment for assisting a first user equipment to operate a target application on the second user equipment according to another aspect of the present application.

Compared with the prior art, in an embodiment of the present application, the first user equipment receives and displays a desktop screenshot sent by the second user equipment, wherein the desktop screenshot includes application identification information of the target application displayed on the second user equipment's desktop; in response to a corresponding user's select operation on the application identification information in the desktop screenshot, converts coordinates of the application identification information on the first user equipment's screen into coordinates of the application identification information on the second user equipment's; sends coordinates of the application identification information on the second user equipment's screen to the second user equipment; an receives an application screenshot of the started target application sent from the second user equipment, so as to implement a simple static picture transmission between the two user equipment. Then, through a coordinate mapping method, the user may freely use an application on another user equipment in a user equipment. This enhances the user's experience in using the app and also reduces the development cost of the app.

### BRIEF DESCRIPTION OF THE ACCOMPANYING DRAWINGS

Other features, objectives, and advantages of the present application will become more apparent through reading the detailed depiction of the non-limiting embodiments with reference to the accompanying drawings.

FIG. 1 illustrates a device schematic diagram of a first user equipment and a second user equipment for operating a target application on a corresponding device according to an aspect of the present application;

FIG. 2 illustrates a schematic diagram of a desktop screenshot sent by a second user equipment to a first user equipment according to an embodiment of the present application;

FIG. 3 illustrates a schematic diagram of a desktop screenshot sent by a second user equipment to a first user equipment according to another embodiment of the present application;

FIG. 4 illustrates a schematic diagram of an application screenshot sent by a second user equipment to a first user equipment according to an embodiment of the present application;

FIG. 5 illustrates a device schematic diagram of a first user equipment and a second user equipment for operating a target application on a corresponding device according to a preferred embodiment of the present application;

FIG. 6 illustrates a schematic diagram of a module screenshot sent by a second user equipment to a first user equipment according to an embodiment of the present application;

FIG. 7 illustrates a flow diagram of a method for operating a target application on a corresponding device with cooperation between a first user equipment and a second user equipment according to another aspect of the present application;

FIG. 8 illustrates a flow diagram of a method for operating a target application on a corresponding device with cooperation between a first user equipment and a second user equipment according to a preferred embodiment of the present application.

In the accompanying drawings, same or similar reference numerals represent same or similar components.

### DETAILED DESCRIPTION OF THE PREFERRED EMBODIMENTS

Hereinafter, the present application will be described in further detail with reference to the accompanying drawings.

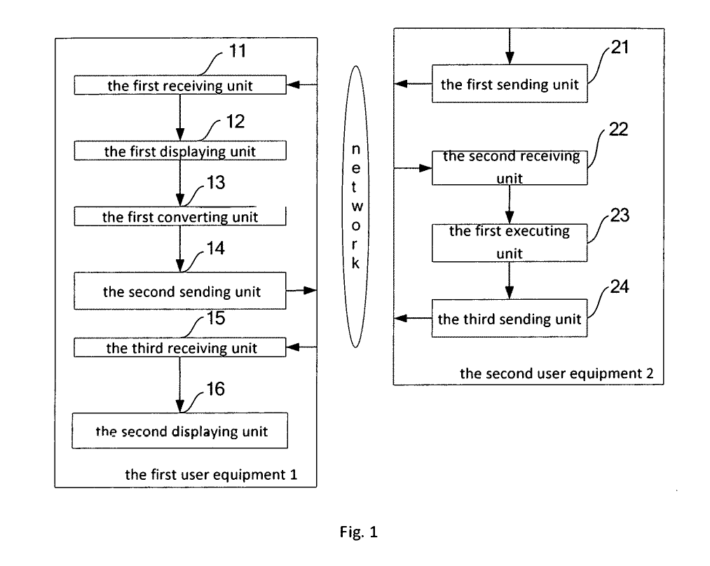

FIG. 1 illustrates a device schematic diagram of a first user equipment 1 and a second user equipment 2 for operating a target application on a corresponding device according to an aspect of the present application, wherein the first user equipment 1 includes a unit configured to receive a desktop screenshot sent by the second user equipment (hereinafter referred to as “a first receiving unit 11”), wherein the desktop screenshot includes application identification information of a target application displayed on the second user equipment's desktop; a unit configured to display the desktop screenshot (hereinafter referred to as “a first displaying unit 12”); a unit configured to, in response to a corresponding user's select operation on the application identification information in the desktop screenshot, convert coordinates of the application identification information on the first user equipment's screen into coordinates of the application identification information on the second user equipment's screen (hereinafter referred to as “a first converting unit 13”); a unit configured to send coordinates of the application identification information on the second user equipment's screen to the second user equipment (hereinafter referred to as “a second sending unit 14”); a unit configured to receive an application screenshot of the started target application sent by the second user equipment (hereinafter referred to as “a third receiving unit 15)”; and a unit configured to display the application screenshot (hereinafter referred to as “a second displaying unit 16”). The second user equipment 2 includes a unit configured to send a desktop screenshot to a corresponding first user equipment (hereinafter referred to as “a first sending unit 21”), wherein the desktop screenshot includes application identification information of a target application displayed on the second user equipment's desktop; a unit configured to receive coordinates of the application identification information on the second user equipment's screen sent by the first user equipment (hereinafter referred to as “a second receiving unit 22”); a unit configured to perform a start application operation at the coordinates to start the target application (hereinafter referred to as “a first executing unit 23”); a unit configured to send an application screenshot of the started target application to the first user equipment (hereinafter referred to as “a third sending unit 24).” Specifically, the first sending unit 21 of the second user equipment 2 sends a desktop screenshot to the first user equipment 1, wherein the desktop screenshot includes application identification information of a target application displayed on the second user equipment's desktop; correspondingly, the first receiving unit 11 of the first user equipment 1 receives the desktop screenshot sent by the second user equipment 2, wherein the desktop screenshot includes application identification information of a target application displayed on the second user equipment's desktop. The first display unit 12 displays the desktop screenshot; and the first converting unit 13, in response to a corresponding user's select operation on the application identification information in the desktop screenshot, converts coordinates of the application identification information on the first user equipment's screen into coordinates of the application identification information on the second user equipment's screen. The second sending unit 14 sends coordinates of the application identification information on the second user equipment's screen to the second user equipment 2; correspondingly, a second receiving unit 22 of the second user equipment 2 receives coordinates of the application identification information on the second user equipment's screen sent by the first user equipment 1. The first executing unit 23 performs a start application operation at the coordinates to start the target application. The third sending unit 24 sends an application screenshot of the started target application to the first user equipment 1; correspondingly, the third receiving unit 15 of the first user equipment 1 receives an application screenshot of the started target application sent by the second user equipment, and the second displaying unit 16 displays the application screenshot.

Here, the first user equipment 1 and the second user equipment 2 may be any electronic product that may perform human-machine interaction with the user through a keyboard, a mouse, a touchpad, a touch screen, or a handwriting device, e.g., a PC, a mobile phone, a smart mobile phone, a wearable device, a PDA, a palm computer PPC, or a tablet computer, etc., wherein the first user equipment 1 and the second user equipment 2 may be connected via WiFi, Bluetooth and the like. Those skilled in the art should understand that the aforesaid user equipment 1 and second user equipment 2 are only examples, and other existing user equipments, or those that can possibly come out later should also be contained in the protection scope of the application, and included here in a way of quotation, if they are adaptable to this application. Here, the first user equipment 1 and the second user equipment 2 both include an electronic device that may automatically perform numerical calculation and information processing according to a pre-set or pre-stored instruction, hardware of which includes, but not limited to, a microprocessor, an application-specific integrated circuit (ASIC), a programmable gate array (FPGA), a digital processor (DSP), and an embedded device, etc.

Specifically, the first sending unit 21 of the second user equipment 2 sends a desktop screenshot to the corresponding first user equipment 1, wherein the desktop screenshot includes application identification information of a target application displayed on the second user equipment's desktop. Here, the desktop screenshot may be all image information of the desktop as viewed by a user on the second user equipment 2, i.e., at this point, the desktop screenshot is a desktop full-screen screenshot of the second user equipment 2; or the desktop screenshot may also be a screenshot only including the application identification information of the target application, i.e., the desktop screenshot at this time is a part of the desktop full-screen screenshot of the second user equipment 2. Here, the target application is a third party application installed in the second user equipment 2, e.g., 360 Safeguard, Youku app, Xinhua Dictionary app, etc. Here, the application identification information is for identifying the target application, which may include one or more of icons, words, images, pictures, animations and the like. Preferably, the words displayed in the application identification information may be dynamically changed, e.g., introducing the target application in an animation form. Those skilled in the art should understand that the aforesaid application identification information is only an example, and other existing application identification information, or those that can possibly come out later should also be contained in the protection scope of the application and included here in a way of quotation, if they are adaptable to this application.

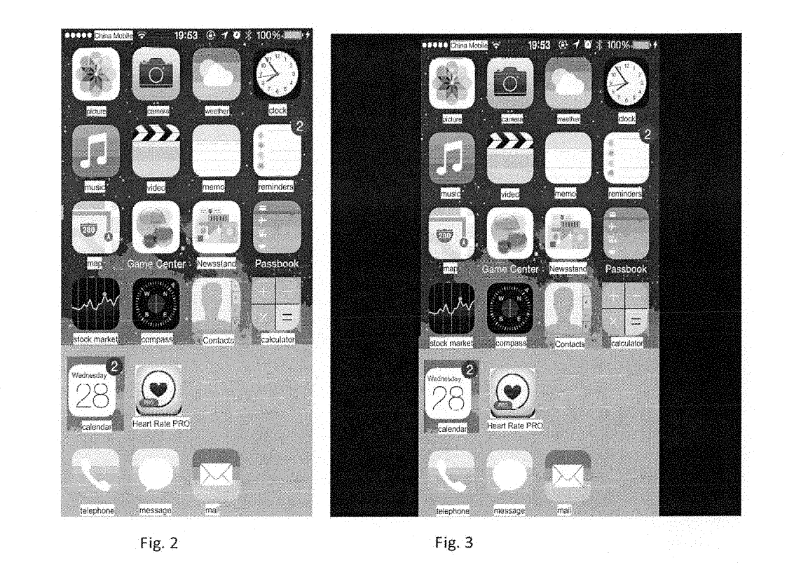

For example, suppose user A has two mobile terminals, a first user equipment 1 and a second user equipment 2, wherein the first user equipment 1 is a tablet computer (UE1) with an IOS operating system, and the screen resolution is 1536*2304, i.e., the UE1 has 1536 pixels in a horizontal direction and 2304 pixels in a vertical direction. The second user equipment 2 is a smart mobile phone (UE2) with an Android operation system, and the screen resolution is 640*960. Suppose the pixel pitch is equal in UE1 and UE2, and UE2 installs an app, e.g., a heart rate detection application HeartRatePRO, while UE1 does not install a similar application. When User A intends to use the app through UE1, he/she has to download an app suitable for UE1's operating system in the prior art; while in the present application, user A may connect UE1 with UE2 through WiFi or the Bluetooth in UE1 and UE2; then, the first sending unit 21 of UE2 may first send a captured desktop screenshot including an application icon of the target application (i.e., HeartRatePRO), which is obtained from screenshot or through an installed screenshot software, to UE1 via WiFi or the Bluetooth, etc. The desktop screenshot may be a desktop full-screenshot of UE2, as illustrated in FIG. 2.

Correspondingly, the first receiving unit 11 of the first user equipment 1 receives a desktop screenshot sent by the second user equipment 2 through WiFi or Bluetooth, etc, wherein the desktop screenshot includes application identification information of a target application displayed on the second user equipment's desktop.

Next, the first displaying unit 12 displays the desktop screenshot. Herein, when the first user equipment 1 displays the desktop screenshot sent by the second user equipment 2, a situation exists that the screen size and aspect ratio of the first user equipment 1 are possible unequal to the screen size and aspect ratio of the second user equipment 2. In this case, the first displaying unit 12 of the first user equipment 1 may first perform adjustment processing like equal scaling on the desktop screenshot, while the adjusted desktop screenshot may be displayed on the first user equipment 1 in the middle of the screen or in full screen; or, after the first user equipment 1 displays the desktop screenshot, a black blank area may also possibly appear. For example, continued with the example above, since the screen resolution of UE1 is 1536*2304, while the screen resolution of UE2 is 640*960, when the first display unit 12 of UE1 displays the desktop screenshot, the lengthwise and widthwise sizes of the original desktop screenshot are both zoomed in 2.4 times by proportion (because 1536/640=2.4, 2304/960=2.4), and displayed in full screen.

Those skilled in the art should understand that the aforesaid manner of displaying the desktop screenshot is only an example, or those that can possibly come out later should also be contained in the protection scope of the application and included here in a way of quotation, if they are adaptable to this application.

The first converting unit 13 first obtains a corresponding user's select operation on the application identification information in the desktop screenshot via an application interface (API) provided by the first user equipment 1 or through an application interface (API) provided by the target application; then, in response to the select operation, converts coordinates of the application identification information on the first user equipment's screen into coordinates of the application identification information on the second user equipment's screen. Here, the select operation may be an operation of the user for starting the target application, e.g., clicking, etc., or may be an operation of the user for adjusting an arrangement position of the target application on the desktop screenshot, e.g., dragging. For example, suppose after User A views the desktop screenshot sent by UE2 on UE1, as illustrated in FIG. 2, he/she clicks the application icon of the target application (i.e., Heart Rate PRO) in the desktop screenshot to start the target application, then the first converting unit 13 will obtain User A's click operation on the application icon of the target application (i.e., Heart Rate PRO) in the desktop screenshot through the application interface (API) provided by UE1; then, in response to the click operation, converts the coordinates of the application icon of Heart Rate Pro on the screen of UE1 into its coordinates on the screen of UE2, e.g., during the procedure in which the first converting unit 13 of UE1 converts the coordinates of the target application on the screen of UE1 into its coordinates on the screen of UE2, it is a reverse processing to the display adjustment processing of the desktop screenshot sent by UE1 to UE2, e.g., suppose a distance of the target application Heart Rate PRO to the left side of the screen in UE2 (with a 640*960 screen resolution) is x, while the distance to the upper side of the screen in UE2 is y, i.e., the coordinates of the target application Heart Rate Pro on the screen of UE2 are (x, y), while when UE1 (with a 1536*2304 screen resolution) displays the desktop screenshot, both of the length and width are expanded 2.4 times of the original, i.e., the distance of the target application Heart Rate Pro to the left side of the screen in UE1 is x′=2.4*x, while its distance to the upper side of the screen in UE1 is y′=2.4*y, i.e., the coordinates of the target application Heart Rate PRO on the screen of UE1 is (x′, y′); correspondingly, during the procedure in which UE1 converts the coordinates of the target application Heart Rate PRO on the screen of UE1 into its coordinates on the screen of UE2, the coordinates of the target application Heart Rate Pro in the screen of UE1 are proportionally zoomed out to 1/2.4.

Those skilled in the art should understand that the aforesaid manner of coordinate conversion is only exemplary, or those that may possibly come out later should also be contained in the protection scope of the application and included here in a way of quotation, if they are adaptable to this application.

Preferably, when the first displaying unit 12 displays the desktop screenshot, if the first user equipment 1's screen size is greater than the user equipment 2's screen size, the first displaying unit 12 may not perform adjustment processing on the desktop screenshot; instead, it directly displays the desktop screenshot according to its size in the second user equipment 2. At this point, a black area will appear on the first user equipment 1's screen, as illustrated in FIG. 3. Wherein, when the first converting unit 13, in response to the select operation, converts coordinates of the application identification information on the first user equipment's screen into coordinates of the application identification information on the second user equipment's, it will use the black frame on the screen of the first user equipment 1 as a benchmark and use the distance of the application identification information to the black frame of the first user equipment 1's screen as the corresponding coordinates on the screen of the second user equipment.

Then, the second sending unit 14 sends the coordinates of the application identification information on the screen of the second user equipment to the second user equipment 2 via WiFi or Bluetooth or the like.

Correspondingly, the second receiving unit 22 of the second user equipment 2 receives the coordinates of the application identification information on the screen of the second user equipment sent by the first user equipment 1 via WiFi or Bluetooth or the like.

The first executing unit 23 performs a start application operation at the coordinates to start the target application. For example, suppose the coordinates of the application identification information on the screen of the second user equipment 2 received by the second receiving unit 22, which are sent from the first user equipment 1, are (x, y), since the desktop screenshot displayed by the second user equipment 2 is of its own, the second user equipment 2 may perform an operation of starting the application at the coordinates so as to actually start the target application Heart Rate PRO, in response to user A's start application click operation on UE1.

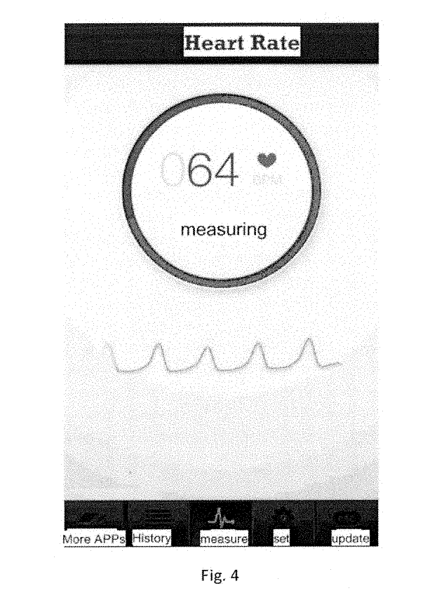

Next, the third sending unit 24 sends the application screenshot of the started target application to the first user equipment 1 via WiFi or Bluetooth or the like. For example, continued with the above example, suppose the picture after the target application Heart Rate PRO is started is illustrated in FIG. 4, the third sending unit 24 first captures the application screenshot by capturing the screen, and then sends the application screenshot of the started target application to the first user equipment 1.

Correspondingly, the third receiving unit 15 of the first user equipment 1 receives the application screenshot of the started target application sent by the second user equipment via WiFi or Bluetooth or the like.

The second displaying unit 16 displays the application screenshot. Here, the manner in which the second displaying unit 16 displays the application screenshot is identical or substantially identical to the manner in which the first displaying unit 12 displays the desktop screenshot. For the sake of brevity, it will not be detailed here, but is incorporated here by reference. Herein, the user may see start of the application in the second user equipment 2 on the screen of the first user equipment 1, and the first user equipment 1 presents change in the starting of the application on the second user equipment 2 in real time, such that the user may use the application that only exists in the second user equipment 2 through the first user equipment 1. This implements cross-platform use of the application, thereby the user's app use experience is enhanced and the development cost of the app is also reduced. Meanwhile, when the user executes an operation on the target application in the desktop screenshot displayed on the first user equipment 1 to adjust the arrangement position of the target application on the desktop screenshot, e.g., a dragging operation and the like, after the second user equipment 2 actually executes the operation and synchronizes the desktop screenshot of the target application whose position has been changed on the desktop to the first user equipment 1, the user may see, in the first user equipment 1, change of the position of the target application on the desktop screen, which, correspondingly, also enhances the user's device use experience.

Herein, those skilled in the art should understand that before the second displaying unit 16 displays the application screenshot, the first user equipment 1 may also pre-process the application screenshot, such that the pre-processed application screenshot may match the screen attribute of the first user equipment.

The various units of the first user equipment 1 and the second user equipment 2 work continuously between each other. Specifically, the first sending unit 21 of the second user equipment 2 continuously sends a desktop screenshot to a corresponding first user equipment 1, wherein the desktop screenshot includes application identification information of a target application displayed on the second user equipment's desktop. Correspondingly, the first receiving unit 11 of the first user equipment 1 continuously receives a desktop screenshot sent by the second user equipment 2, wherein the desktop screenshot includes application identification information of a target application displayed on the second user equipment's desktop. The first displaying unit 12 continuously displays the desktop screenshot; and the first converting unit 13 continuously converts coordinates of the application identification information on the first user equipment's screen into coordinates of the application identification information on the second user equipment's screen, in response to a corresponding user's select operation on the application identification information in the desktop screenshot. The second sending unit 14 continuously sends coordinates of the application identification information on the second user equipment's screen to the second user equipment 2. Correspondingly, the second receiving unit 22 of the second user equipment 2 continuously receives coordinates of the application identification information on the second user equipment's screen sent by the first user equipment 1. The first executing unit 23 continuously performs a start application operation at the coordinates to start the target application; and the third sending unit 24 continuously sends an application screenshot of the started target application to the first user equipment 1. Correspondingly, the third receiving unit 15 of the first user equipment 1 continuously receives an application screenshot of the started target application sent by the second user equipment; and the second displaying unit 16 continuously displays the application screenshot. Here, those skilled in the art should understand that the “continuously” means that the various units of the first user equipment 1 and the second user equipment 2 continuously perform sending, receiving, and displaying of the desktop screenshot, coordinate conversion, sending and receiving of the converted coordinates, starting of the target application, and sending, receiving and displaying of the application screenshot of the started target application, till the second user equipment 2 stops sending the desktop screenshot to the first user equipment 1 within a relatively long time.

Preferably, the first user equipment 1 further includes a unit (hereinafter referred to as “a pre-processing unit,” not shown) configured to performs pre-processing on the desktop screenshot so as to obtain a desktop screenshot matching screen attribute of the first user equipment. Specifically, the pre-processing unit performs pre-processing on the desktop screenshot so as to obtain a desktop screenshot matching screen attribute of the first user equipment; wherein the first displaying unit 12 displays the pre-processed desktop screenshot.

Specifically, the pre-processing unit performs pre-processing on the desktop screenshot so as to obtain a desktop screenshot matching screen attribute of the first user equipment. Here, the screen attribute includes, but not limited to, information reflecting screen attributes of the first user equipment, such as screen size, resolution, aspect ratio, etc. Preferably, the pre-processing includes at least any one of the following:
performing adjustment processing on the desktop screenshot according to the first user equipment's screen size and the second user equipment's screen size;
performing adjustment processing on the desktop screenshot according to the first user equipment's aspect ratio and the second user equipment's aspect ratio.

For example, when the pre-processing includes performing adjustment processing on the desktop screenshot according to the first user equipment's screen size and the second user equipment's screen size, for two mobile terminals UE1 and UE2 of user A, UE1's screen resolution is 1536*2304, while UE2's screen resolution is 640*960. Suppose the pixel pitch of UE1 is equal to that of UE2, since UE2 installs an app such as Heart Rate PRO while UE1 does not install such similar application. When user A intends to use the app through UE1, the desktop screenshot sent by UE2 and received by UE1 is shown in FIG. 2. Since the screen size of UE1 is 2.4 times the screen size of UE2, the UE1's pre-processing unit may pre-process the desktop screenshot to enlarge the length and width sizes of the desktop screenshot illustrated in FIG. 2 by 2.4 times, so as to match the screen attribute of UE1.

Then, the first displaying unit 12 displays the pre-processed desktop screenshot. For example, continued with the example above, the pre-processing unit enlarges the length and width sizes of the desktop screenshot of FIG. 2 by 2.4 times proportionally; now, the first displaying unit 12 displays the pre-processed desktop screenshot in full screen.

In a preferred embodiment (with reference to FIG. 1), the first user equipment 1 further includes a unit (hereinafter referred to as “an operation request sending unit,” not shown) configured to send to the second user equipment the user's operation request regarding the target application in the second user equipment. The second user equipment 2 further includes a unit (hereinafter referred to as “an operation request receiving unit,” not shown) configured to receive a corresponding user's operation request regarding the target application in the second user equipment sent by the first user equipment. Specifically, an operating request sending unit of the first user equipment 1 sends to the second user equipment 2 the user's operation request regarding the target application in the second user equipment. Correspondingly, the operation request receiving unit of the second user equipment 2 receives the corresponding user's operation request regarding the target application in the second user equipment sent by the first user equipment. The first sending unit 21 sends a desktop screenshot to a first user equipment in response to the operation request, wherein the desktop screenshot includes application identification information of the target application displayed on the second user equipment's desktop.

Specifically, the operation request sending unit of the first user equipment 1 sends to the second user equipment 2 the user's operation request regarding the target application in the second user equipment via WiFi or Bluetooth or the like. For example, when the corresponding user A intends to use the app like Heart Rate Pro installed in UE2 through UE1, he/she may voluntarily send an operation request for using the app in UE2 via UE1, e.g., by connecting the Bluetooth of UE1 with the Bluetooth of UE2, and then sends agreement information to UE2 via UE1 so as to request for using the heart rate detection application Heart Rate Pro in UE2. Here, by sending to the second user equipment 2 the user's operation request regarding the target application in the second user equipment, the present application causes that it is not in any case that the second user equipment 2 will send to the first user equipment 1 a desktop screenshot of the application identification information of the target application displayed on the desktop of the second user equipment, which avoids the interference to the user caused by voluntarily sending of a desktop screenshot by UE2 while the user does not want UE2 to send the desktop screenshot to UE1, after the UE1 and UE2 are connected via WiFi or Bluetooth, and further enhances the user's experience in using the device and app.

Correspondingly, the operation request receiving unit of the second user equipment 2 receives, via WiFi or Bluetooth, the corresponding user's operation request regarding the target application in the second user equipment sent by the first user equipment.

The first sending unit 21 sends a desktop screenshot to the first user equipment via WiFi or Bluetooth or the like in response to the operation request, wherein the desktop screenshot Includes application identification information of the target application displayed on the second user equipment's desktop.

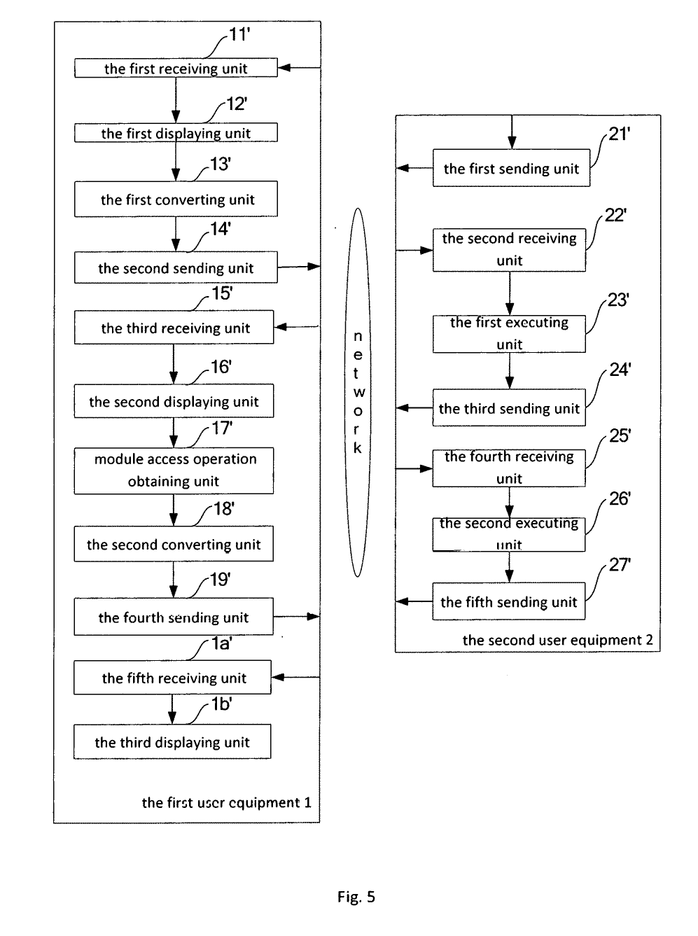

FIG. 5 illustrates a device schematic diagram of a first user equipment 1 and a second user equipment 2 for operating a target application on a corresponding device according to a preferred embodiment of the present application, wherein the first user equipment 1 includes a first sending unit 11′, a first displaying unit 12′, a first converting unit 13′, a second sending unit 14′, a third receiving unit 15′, and a second displaying unit 16′. The first user equipment 1 further includes a unit (hereinafter referred to as “module access operation obtaining unit 17”) configured to obtain an access operation executed by the user to a function module of the target application in the application screenshot; a unit (hereinafter referred to as “a second converting unit 18”) configured to convert, in response to the access operation, coordinates of the function module on the first user equipment's screen into coordinates of the function module on the second user equipment's screen; a unit (hereinafter referred to as “a fourth sending unit 19”) configured to send the coordinates of the function module on the second user equipment's screen to the second user equipment; a unit (hereinafter referred to as “a fifth receiving unit 1a”) configured to receive a module screenshot of the started function module sent by the second user equipment; a unit (hereinafter referred to as “a third displaying unit 1b′”) configured to display the module screenshot. The second user equipment 2 includes a first sending unit 21′, a second receiving unit 22′, a first executing unit 23′, and a third sending unit 24′. The second user equipment 2 further includes a unit (hereinafter referred to as “a fourth receiving unit 25”) configured to receive coordinates of a function module of the target application accessed by a corresponding user on the second user equipment's screen, sent by the first user equipment; a unit configured to execute a module access operation at coordinates of the function module on the second user equipment's screen so as to start the function module (hereinafter referred to as “a second executing unit 26′”); a unit (hereinafter referred to as “a fifth sending unit 27”) configured to send the module screenshot of the started function module to the first user equipment. Here, the first sending unit 11′, the first displaying unit 12′, the first converting unit 13′, the second sending unit 14′, the third receiving unit 15′, and the second displaying unit 16′ of the first user equipment 1, and the first sending unit 21′, the second receiving unit 22′, the first executing unit 23′, and the third sending unit 24′ of the second user equipment 2 are identical or substantially identical to the content of corresponding units in the embodiment of FIG. 1, respectively. Here, for the sake of brevity, they will not be detailed here, but are incorporated here by reference.

Specifically, the module access operation obtaining unit 17′ of the first user equipment 1 obtains, by invoking an application interface (API) provided by the first user equipment 1, an access operation on the target application as executed by the user in the application screenshot, e.g., the user's click onto the function module, etc. For example, for user A, after he/she views an application screenshot of the target application Heart Rate PRO returned by UE2 on the screen of UE1, he/she clicks onto the function module (e.g., “historical records”) of the application, the module access operation obtaining unit 17′ of UE1 may obtain the user A's click operation on the function module “historical records” of the target application Heart Rate PRO executed by user A in the application screenshot.

The second converting unit 18′, in response to the access operation, converts the coordinates of the function module on the screen of the first user equipment into coordinates of the function module on the screen of the second user equipment. Here, the manner in which the second converting unit 18′ converts coordinates of the function module on the screen of the first user equipment into the coordinates of the function module on the screen of the second user equipment is identical or substantially identical to the manner in which the first converting unit 13 converts the coordinates of the application identification information on the screen of the first user equipment into the coordinates of the application identification information on the screen of the second user equipment. Here, for the sake of brevity, it will not be detailed here, but is incorporated here by reference.

The fourth sending unit 19′ sends the coordinates of the function module on the screen of the second user equipment to the second user equipment via WiFi or Bluetooth or the like.

Correspondingly, the fourth receiving unit 25′ of the second user equipment 2 receives coordinates of a function module of the target application accessed by a corresponding user on the second user equipment's screen, sent by the first user equipment, via WiFi or Bluetooth.

The second executing unit 26′ executes a module access operation at the coordinates of the function module on the screen of the second user equipment so as to start the function module. Here, the manner in which the second executing unit 26′ starts the function module is identical or substantially identical to the manner in which the first executing unit 23 starts the target application in the embodiment of FIG. 1. Here, for the sake of brevity, it will not be detailed here and is incorporated here by reference.

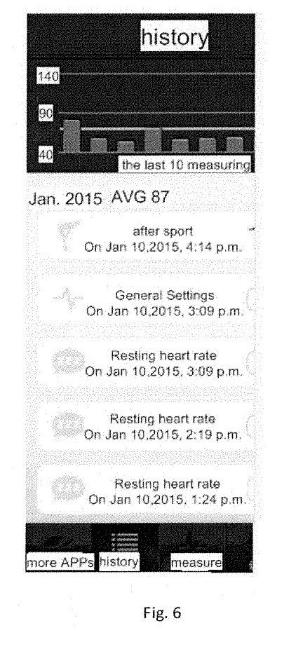

Next, the fifth sending unit 27′ first captures a module screenshot of the started function module by capturing the screen or the like; and then sends the module screenshot to the first user equipment via WiFi or Bluetooth, etc. For example, for the target application Heart Rate PRO, after the second executing unit 26′ of the second user equipment 2 starts the function module “historical records”, the picture is shown in FIG. 6; then the fifth sending unit 27′ sends the module screenshot to the first user equipment 1.

Correspondingly, the fifth receiving unit 1a′ of the first user equipment 1 receives a module screenshot of the started function module sent by the second user equipment via WiFi or Bluetooth, etc.

The third displaying unit 1b′ displays the mobile screenshot. Here, the manner in which the third displaying unit 1b′ displays the module screenshot is identical or substantially identical to the manner in which the first displaying unit 12 displays the desktop screenshot in the embodiment of FIG. 1. Here, for the sake of brevity, it will not be detailed here and is incorporated here by reference.

Those skilled in the art should understand, in a specific embodiment, the first displaying unit 12′, the second displaying unit 16′, and the third displaying unit 1b′ of the first user equipment 1 may be separate unit or may be integrated together.

Those skilled in the art should understand that in a specific embodiment, the first executing unit 23′ and the second executing unit 26′ of the second user equipment 2 may be separate unit or may be integrated together.

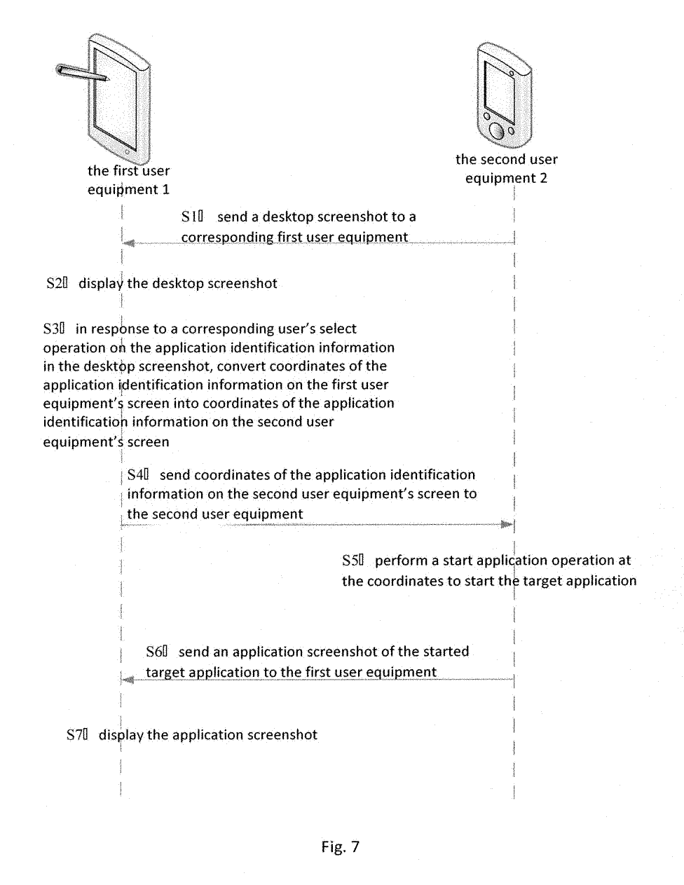

FIG. 7 illustrates a flow diagram of a method for operating a target application on a corresponding device with cooperation between a first user equipment and a second user equipment according to another aspect of the present application.

Wherein, the method includes step S1, step S2, step S3, step S4, step S5, step S6, and step S7.

Specifically, in the step S1, the second user equipment 2 sends a desktop screenshot to the corresponding first user equipment 1, wherein the desktop screenshot includes application identification information of a target application displayed on the second user equipment's desktop. Correspondingly, the first user equipment 1 receives the desktop screenshot sent by the second user equipment 2, wherein the desktop screenshot includes application identification information of a target application displayed on the second user equipment's desktop. In the step S2, the first user equipment 1 displays the desktop screenshot. In the step S3, the first user equipment 1, in response to a corresponding user's select operation on the application identification information in the desktop screenshot, converts coordinates of the application identification information on the first user equipment's screen into coordinates of the application identification information on the second user equipment's screen. In the step S4, the first user equipment 1 sends coordinates of the application identification information on the second user equipment's screen to the second user equipment 2. Correspondingly, the second user equipment 2 receives coordinates of the application identification information on the second user equipment's screen sent by the first user equipment 1. In the step S5, the second user equipment 2 performs a start application operation at the coordinates to start the target application. In the step S6, the second user equipment 2 sends an application screenshot of the started target application to the first user equipment 1. Correspondingly, the first user equipment 1 receives an application screenshot of the started target application sent by the second user equipment, and in the step S7, the first user equipment 1 displays the application screenshot.

Here, the first user equipment 1 and the second user equipment 2 may be any electronic product that may perform human-machine interaction with the user through a keyboard, a mouse, a touchpad, a touch screen, or a handwriting device, e.g., a PC, a mobile phone, a smart mobile phone, a wearable device, a PDA, a palm computer PPC, or a tablet computer, etc., wherein the first user equipment 1 and the second user equipment 2 may be connected via WiFi, Bluetooth and the like. Those skilled in the art should understand that the aforesaid user equipment 1 and second user equipment 2 are only examples, and other existing user equipments, or those that may possibly come out later should also be contained in the protection scope of the application and included here in a way of quotation, if they are adaptable to this application. Here, the first user equipment 1 and the second user equipment 2 both include an electronic device that may automatically perform numerical calculation and information processing according to a pre-set or pre-stored instruction, hardware of which includes, but not limited to, a microprocessor, an application-specific integrated circuit (ASIC), a programmable gate array (FPGA), a digital processor (DSP), and an embedded device, etc.

Specifically, in the step S1, the second user equipment 2 sends a desktop screenshot to the corresponding first user equipment 1, wherein the desktop screenshot includes application identification information of a target application displayed on the second user equipment's desktop. Here, the desktop screenshot may be all image information of the desktop as viewed by a user on the second user equipment 2, i.e., at this point, the desktop screenshot is a desktop full-screen screenshot of the second user equipment 2; or the desktop screenshot may also be a screenshot only including the application identification information of the target application, i.e., the desktop screenshot at this time is a part of the desktop full-screen screenshot of the second user equipment 2. Here, the target application is a third party application installed in the second user equipment 2, e.g., 360 Safeguard, Youku app, Xinhua Dictionary app, etc. Here, the application identification information is for identifying the target application, which may include one or more of icons, words, images, pictures, animations and the like. Preferably, the words displayed in the application identification information may be dynamically changed, e.g., introducing the target application in an animation form. Those skilled in the art should understand that the aforesaid application identification information is only an example, and other existing application identification information, or those that can possibly come out later should also be contained in the protection scope of the application and included here in a way of quotation, if they are adaptable to this application.

For example, suppose user A has two mobile terminals, a first user equipment 1 and a second user equipment 2, wherein the first user equipment 1 is a tablet computer (UE1) with an IOS operating system, and the screen resolution is 1536*2304, i.e., the UE1 has 1536 pixels in a horizontal direction and 2304 pixels in a vertical direction. The second user equipment 2 is a smart mobile phone (UE2) with an Android operation system, and the screen resolution is 640*960. Suppose the pixel pitch is equal in UE1 and UE2, and UE2 installs an app, e.g., a heart rate detection application HeartRatePRO, while UE1 does not install a similar application. When User A intends to use the app through UE1, he/she has to download an app suitable for UE1's operating system in the prior art; while in the present application, user A may connect UE1 with UE2 through WiFi or the Bluetooth in UE1 and UE2; then, in the step S1, UE2 may first send a captured desktop screenshot including an application icon of the target application (i.e., HeartRatePRO), which is obtained from screenshot or through an installed screenshot software, to UE1 via WiFi or the Bluetooth, etc. The desktop screenshot may be a desktop full-screenshot of UE2, as illustrated in FIG. 2.

Correspondingly, the first user equipment 1 receives a desktop screenshot sent by the second user equipment 2 through WiFi or Bluetooth, etc wherein the desktop screenshot includes application identification information of a target application displayed on the second user equipment's desktop.

Next, in the step S2, the first user equipment 1 displays the desktop screenshot. Herein, when the first user equipment 1 displays the desktop screenshot sent by the second user equipment 2, a situation exists that the screen size and aspect ratio of the first user equipment 1 are possible unequal to the screen size and aspect ratio of the second user equipment 2. In this case, in the step S2, the first user equipment 1 may first perform adjustment processing like equal scaling on the desktop screenshot, while the adjusted desktop screenshot may be displayed on the first user equipment 1 in the middle of the screen or in full screen; or, after the first user equipment 1 displays the desktop screenshot, a black blank area may also possibly appear. For example, continued with the example above, since the screen resolution of UE1 is 1536*2304, while the screen resolution of UE2 is 640*960, when in the step S2, UE1 displays the desktop screenshot, the lengthwise and widthwise sizes of the original desktop screenshot are both zoomed in 2.4 times by proportion (because 1536/640=2.4, 2304/960=2.4), and displayed in full screen.

Those skilled in the art should understand that the aforesaid manner of displaying the desktop screenshot is only an example, or those that may possibly come out later should also be contained in the protection scope of the application and included here in a way of quotation, if they are adaptable to this application.

In the step S3, the first user equipment 1 first obtains a corresponding user's select operation on the application identification information in the desktop screenshot via an application interface (API) provided by the first user equipment 1 or through an application interface (API) provided by the target application. Then, in response to the select operation, the first user equipment 1 converts coordinates of the application identification information on the first user equipment's screen into coordinates of the application identification information on the second user equipment's screen. Here, the select operation may be an operation of the user to start the target application, e.g., click, etc., or may be an operation of the user to adjust an arrangement position of the target application on the desktop screenshot, e.g., dragging. For example, suppose after User A views the desktop screenshot sent by UE2 on UE1, as illustrated in FIG. 2, he/she clicks the application icon of the target application (i.e., Heart Rate PRO) in the desktop screenshot to start the target application. Then in the step S3, the first user equipment 1 will obtain User A's click operation on the application icon of the target application (i.e., Heart Rate PRO) in the desktop screenshot through the application interface (API) provided by UELThen, in response to the click operation, the first user equipment 1 converts the coordinates of the application icon of Heart Rate Pro on the screen of UE1 into its coordinates on the screen of UE2, e.g., during the procedure in which UE1 converts the coordinates of the target application on the screen of UE1 into its coordinates on the screen of UE2 in the step S3, it is a reverse processing to the display adjustment processing of the desktop screenshot sent by UE1 to UE2, e.g., suppose a distance of the target application Heart Rate PRO to the left side of the screen in UE2 (with a 640*960 screen resolution) is x, while the distance to the upper side of the screen in UE2 is y, i.e., the coordinates of the target application Heart Rate Pro on the screen of UE2 are (x, y), while when UE1 (with a 1536*2304 screen resolution) displays the desktop screenshot, both of the length and width are expanded 2.4 times that of the original, i.e., the distance of the target application Heart Rate Pro to the left side of the screen in UE1 is x′=2.4*x, while its distance to the upper side of the screen in UE1 is y′=2.4*y, i.e., the coordinates of the target application Heart Rate PRO on the screen of UE1 is (x′, y′). Correspondingly, during the procedure in which UE1 converts the coordinates of the target application Heart Rate PRO on the screen of UE1 into its coordinates on the screen of UE2, the coordinates of the target application Heart Rate Pro in the screen of UE1 are proportionally zoomed out to 1/2.4.

Those skilled in the art should understand that the aforesaid manner of coordinate conversion is only exemplary, or those that may possibly come out later should also be contained in the protection scope of the application and included here in a way of quotation, if they are adaptable to this application.

Preferably, when in the step S2, the first user equipment 1 displays the desktop screenshot, if the first user equipment 1's screen size is greater than the user equipment 2's screen size, in the step S2, the first user equipment 1 may not perform adjustment processing′ on the desktop screenshot; instead, it directly displays the desktop screenshot according to its size in the second user equipment 2. At this point, a black area will appear on the first user equipment 1's screen, as illustrated in FIG. 3. Wherein, when in the step S3, the first user equipment 1, in response to the select operation, converts coordinates of the application identification information on the first user equipment's screen into coordinates of the application identification information on the second user equipment's, it will use the black frame on the screen of the first user equipment 1 as a benchmark and use the distance of the application identification information to the black frame of the first user equipment screen as the corresponding coordinates on the screen of the second user equipment.

Then, in the step S4, the first user equipment 1 sends the coordinates of the application identification information on the screen of the second user equipment to the second user equipment 2 via WiFi or Bluetooth or the like.

Correspondingly, the second user equipment 2 receives the coordinates of the application identification information on the screen of the second user equipment sent by the first user equipment 1 via WiFi or Bluetooth or the like.

In the step S5, the second user equipment 2 performs a start application operation at the coordinates to start the target application. For example, suppose the coordinates of the application identification information on the screen of the second user equipment 2, which are sent from the first user equipment 1 and received by the second user equipment 2 in the step S4, are (x, y), since the desktop screenshot displayed by the second user equipment 2 is of its own, the second user equipment 2 may perform an operation of starting the application at the coordinates so as to actually start the target application Heart Rate PRO in response to user A's start application click operation on UE1.

Next, in the step S6, the second user equipment 2 sends the application screenshot of the started target application to the first user equipment 1 via WiFi or Bluetooth or the like. For example, continued with the above example, suppose the picture after the target application Heart Rate PRO is started is as illustrated in FIG. 4, in the step S6, the second user equipment 2 first captures the application screenshot by capturing the screen, and then sends the application screenshot of the started target application to the first user equipment 1.

Correspondingly, the first user equipment 1 receives the application screenshot of the started target application sent by the second user equipment via WiFi or Bluetooth or the like.

In the step S7, the first user equipment 1 displays the application screenshot. Here, the manner in which the first user equipment 1 displays the application screenshot in the step S7 is identical or substantially identical to the manner in which the first user equipment 1 displays the desktop screenshot in the step S2. For the sake of brevity, it will not be detailed here, but is incorporated here by reference. Herein, the user may see start of the application in the second user equipment 2 on the screen of the first user equipment 1, and the first user equipment 1 presents change of the starting of the application on the second user equipment 2 in real time, such that the user may use the application that only exists in the second user equipment 2 through the first user equipment 1. This implements cross-platform use of the application, thereby the user's app use experience is enhanced and the development cost of the app is also reduced. Meanwhile, when the user executes an operation on the target application in the desktop screenshot displayed on the first user equipment 1 to adjust the arrangement position of the target application on the desktop screenshot, e.g., a dragging operation and the like, after the second user equipment 2 actually executes the operation and synchronizes the desktop screenshot of the target application whose position has been changed on the desktop to the first user equipment 1, the user may see, in the first user equipment 1, change of the position of the target application on the desktop screen, which, correspondingly, also enhances the user's device use experience.

Here, those skilled in the art should understand that before the first user equipment 1 displays the application screenshot in the step S7, the first user equipment 1 may also pre-process the application screenshot, such that the pre-processed application screenshot may match the screen attribute of the first user equipment.

The various steps of the first user equipment 1 and the second user equipment 2 work continuously between each other. Specifically, in the step S1, the second user equipment 2 continuously sends a desktop screenshot to a corresponding first user equipment 1, wherein the desktop screenshot includes application identification information of a target application displayed on the second user equipment's desktop. Correspondingly, the first user equipment 1 continuously receives a desktop screenshot sent by the second user equipment 2, wherein the desktop screenshot includes application identification information of a target application displayed on the second user equipment's desktop. In the step S2, the first user equipment 1 continuously displays the desktop screenshot. In the step S3, the first user equipment 1 continuously converts coordinates of the application identification information on the first user equipment's screen into coordinates of the application identification information on the second user equipment's screen, in response to a corresponding user's select operation on the application identification information in the desktop screenshot. In the step S4, the first user equipment 1 continuously sends coordinates of the application identification information on the second user equipment's screen to the second user equipment 2. Correspondingly, the second user equipment 2 continuously receives coordinates of the application identification information on the second user equipment's screen sent by the first user equipment 1. In the step S5, the second user equipment 2 continuously performs a start application operation at the coordinates to start the target application. In the step S6, the second user equipment 2 continuously sends an application screenshot of the started target application to the first user equipment 1. Correspondingly, the first user equipment 1 continuously receives an application screenshot of the started target application sent by the second user equipment. In the step S7, the first user equipment 1 continuously displays the application screenshot. Here, those skilled in the art should understand that the “continuously” means that the various steps of the first user equipment 1 and the second user equipment 2 continuously perform sending, receiving, and displaying of the desktop screenshot, coordinate conversion, sending and receiving of the converted coordinates, starting of the target application, and sending, receiving and displaying of the application screenshot of the started target application, till the second user equipment 2 stops sending the desktop screenshot to the first user equipment 1 within a relatively long time.

Preferably, the method further includes the step S14 (not shown). Specifically, in the step S14, the first user equipment 1 performs pre-processing on the desktop screenshot so as to obtain a desktop screenshot matching screen attribute of the first user equipment; wherein in the step S2, the first user equipment 1 displays the pre-processed desktop screenshot.

Specifically, in the step S14, the first user equipment 1 performs pre-processing on the desktop screenshot so as to obtain a desktop screenshot matching screen attribute of the first user equipment. Here, the screen attribute includes, but not limited to, information reflecting screen attributes of the first user equipment, such as screen size, resolution, aspect ratio, etc. Preferably, the pre-processing includes at least any one of the following:
performing adjustment processing on the desktop screenshot according to the first user equipment's screen size and the second user equipment's screen size;
performing adjustment processing on the desktop screenshot according to the first user equipment's aspect ratio and the second user equipment's aspect ration.

For example, when the pre-processing includes performing adjustment processing on the desktop screenshot according to the first user equipment's screen size and the second user equipment's screen size, for two mobile terminals UE1 and UE2 of user A, UE1's screen resolution is 1536*2304, while UE2's screen resolution is 640*960. Suppose the pixel pitch of UE1 is equal to that of UE2, since UE2 installs an app such as Heart Rate PRO while UE1 does not install such similar application. When user A intends to use the app through UE1, the desktop screenshot sent by UE2 and received by UE1 is shown in FIG. 2; since the screen size of UE1 is 2.4 times the screen size of UE2, the UE1's pre-processing unit may pre-process the desktop screenshot to enlarge the length and width sizes of the desktop screenshot illustrated in FIG. 2 by 2.4 times, so as to match the screen attribute of UE1.

Then, in the step S2, the first user equipment 1 displays the pre-processed desktop screenshot. For example, continued with the example above, in the step S14, the first user equipment 1 enlarges the length and width sizes of the desktop screenshot of FIG. 2 by 2.4 times proportionally. At this time, in the step S2, the first user equipment 1 displays the pre-processed desktop screenshot in full screen.

In a preferred embodiment (with reference to FIG. 7), the method further includes step S15 (not shown). Specifically, in the step S15, the first user equipment 1 sends the user's operation request regarding the target application in the second user equipment to the second user equipment 2. Correspondingly, the second user equipment 2 receives the corresponding user's operation request regarding the target application in the second user equipment sent by the first user equipment. In the step S1, the second user equipment 2 sends a desktop screenshot to a first user equipment in response to the operation request, wherein the desktop screenshot includes application identification information of the target application displayed on the second user equipment's desktop.

Specifically, in the step S15, the first user equipment 1 sends the user's operation request regarding the target application in the second user equipment to the second user equipment 2 via WiFi or Bluetooth or the like. For example, when the corresponding user A intends to use the app like Heart Rate Pro installed in UE2 through UE1, he/she may voluntarily send an operation request for using the app in UE2 via UE1, e.g., by connecting the Bluetooth of UE1 with the Bluetooth of UE2, and then sends agreement information to UE2 via UE1 so as to request for using the heart rate detection application Heart Rate Pro in UE2. Here, by sending the user's operation request regarding the target application in the second user equipment to the second user equipment 2, the present application causes that it is not in any case that the second user equipment 2 will send a desktop screenshot of the application identification information of the target application displayed on the desktop of the second user equipment to the first user equipment 1, which avoids the interference to the user caused by voluntarily sending a desktop screenshot by UE2 while the user does not want UE2 to send the desktop screenshot to UE1 after the UE1 and UE2 are connected via WiFi or Bluetooth, and further enhances the user's experience in using the device and app.

Correspondingly, the second user equipment 2 receives, via WiFi or Bluetooth, the corresponding user's operation request regarding the target application in the second user equipment sent by the first user equipment.

Next, in the step S1, the second user equipment 2 sends a desktop screenshot to the first user equipment via WiFi or Bluetooth or the like in response to the operation request, wherein the desktop screenshot includes application identification information of the target application displayed on the second user equipment's desktop.

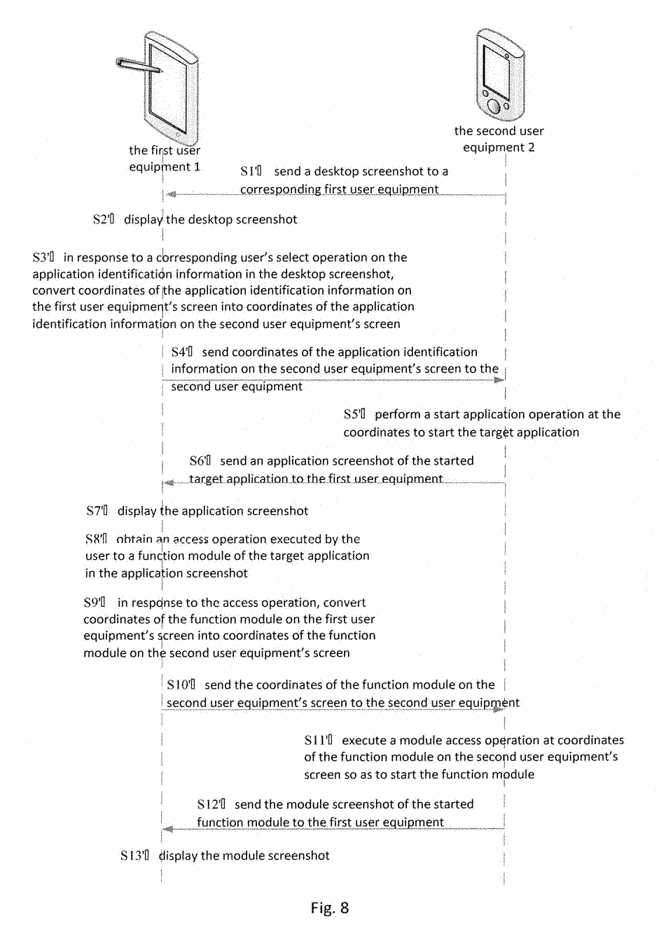

FIG. 8 illustrates a flow diagram of a method for operating a target application on a corresponding device with cooperation between a first user equipment and a second user equipment according to a preferred embodiment of the present application.

Wherein, the method includes step S1′, step S2′, step S3′, step S4′, step S5′, step S6′, and step S7′, step S8′, step S9′, step S10′, step S11′ and step S12′.

Specifically, in the step S1′, the second user equipment 2 sends a desktop screenshot to the corresponding first user equipment 1, wherein the desktop screenshot includes application identification information of a target application displayed on the second user equipment's desktop. Correspondingly, the first user equipment 1 receives the desktop screenshot sent by the second user equipment 2, wherein the desktop screenshot includes application identification information of a target application displayed on the second user equipment's desktop. In the step S2′, the first user equipment 1 displays the desktop screenshot. In the step S3′, the first user equipment 1, in response to a corresponding user's select operation on the application identification information in the desktop screenshot, converts coordinates of the application identification information on the first user equipment's screen into coordinates of the application identification information on the second user equipment's screen. In the step S4′, the first user equipment 1 sends coordinates of the application identification information on the second user equipment's screen to the second user equipment 2. Correspondingly, the second user equipment 2 receives coordinates of the application identification information on the second user equipment's screen sent by the first user equipment 1. In the step S5′, the second user equipment 2 performs a start application operation at the coordinates to start the target application. In the step S6′, the second user equipment 2 sends an application screenshot of the started target application to the first user equipment 1. Correspondingly, the first user equipment 1 receives an application screenshot of the started target application sent by the second user equipment, and in the step S7′, the first user equipment 1 displays the application screenshot. In the step S8′, the first user equipment 1 obtains an access operation executed by the user to a function module of the target application in the application screenshot. In the step S9′, the first user equipment 1 converts, in response to the access operation, coordinates of the function module on the first user equipment's screen into coordinates of the function module on the second user equipment's screen. In the step S10′, the first user equipment 1 sends the coordinates of the function module on the second user equipment's screen to the second user equipment. Correspondingly, the second user equipment 2 receives coordinates of a function module of the target application accessed by a corresponding user on the second user equipment's screen, sent by the first user equipment. In the step S11′, the second user equipment 2 executes a module access operation at coordinates of the function module on the second user equipment's screen so as to start the function module. In the step S12′, the second user equipment 2 sends the module screenshot of the started function module to the first user equipment. Correspondingly, the first user equipment 1 receives a module screenshot of the started function module sent by the second user equipment. Here, step S1′, step S2′, step S3′, step S4′, step S5′, step S6′, and step S7′ are identical or substantially identical to the content of corresponding steps in the embodiment of FIG. 7, respectively. Here, for the sake of brevity, they will not be detailed here, but are incorporated here by reference.

Specifically, in the step S8′, the first user equipment 1 obtains, by invoking an application interface (API) provided by the first user equipment 1, an access operation on the target application as executed by the user in the application screenshot, e.g., the user's click onto the function module, etc. For example, for user A, after he/she views an application screenshot of the target application Heart Rate PRO returned by UE2 on the screen of UE1, he/she clicks onto the function module (e.g., “historical records”) of the application, in the step S8′, UE1 may obtain the user A's click operation on the function module “historical records” of the target application Heart Rate PRO executed by user A in the application screenshot.

In the step S9′, the first user equipment 1, in response to the access operation, converts the coordinates of the function module on the screen of the first user equipment into coordinates of the function module on the screen of the second user equipment. Here, the manner in which the first user equipment 1 converts coordinates of the function module on the screen of the first user equipment into the coordinates of the function module on the screen of the second user equipment in the step S9′ is identical or substantially identical to the manner in which the first user equipment 1 converts the coordinates of the application identification information on the screen of the first user equipment into the coordinates of the application identification information on the screen of the second user equipment in the step S3. Here, for the sake of brevity, it will not be detailed here, but is incorporated here by reference.

In the step S10′, the first user equipment 1 sends the coordinates of the function module on the screen of the second user equipment to the second user equipment via WiFi or Bluetooth or the like.

Correspondingly, the second user equipment 2 receives coordinates of a function module of the target application accessed by a corresponding user on the second user equipment's screen, sent by the first user equipment, via WiFi or Bluetooth.

In the step S11′, the second user equipment 2 executes a module access operation at the coordinates of the function module on the screen of the second user equipment so as to start the function module. Here, the manner in which the second user equipment 2 starts the function module in the step S11′ is identical or substantially identical to the manner in which the second user equipment 2 starts the target application in the step S5 in an embodiment of FIG. 7. Here, for the sake of brevity, it will not be detailed here and is incorporated here by reference.

Next, in the step S12′, the second user equipment 2 first captures a module screenshot of the started function module by capturing the screen or the like; and then sends the module screenshot to the first user equipment via WiFi or Bluetooth, etc. For example, for the target application Heart Rate PRO, after the second user equipment 2 starts the function module “historical records” in the step S11′, the picture is shown in FIG. 6; then in the step S12′, the second user equipment 2 sends the module screenshot to the first user equipment 1.

Correspondingly, the first user equipment 1 receives a module screenshot of the started function module sent by the second user equipment via WiFi or Bluetooth, etc.

In the step S13′, the first user equipment 1 displays the mobile screenshot. Here, the manner in which the first user equipment 1 displays the module screenshot in the step S13′ is identical or substantially identical to the manner in which the first user equipment 1 displays the desktop screenshot in the step S2 in the embodiment of FIG. 7. Here, for the sake of brevity, it will not be detailed here and is incorporated here by reference.

It should be noted that the present disclosure may be implemented in software or a combination of software and hardware; for example, it may be implemented by a dedicated integrated circuit (ASIC), a general-purpose computer, or any other similar hardware device. In an embodiment, the software program of the present disclosure may be executed by a processor so as to implement the above steps or functions. Likewise, the software program of the present disclosure (including relevant data structure) may be stored in a computer readable recording medium, for example, a RAM memory, a magnetic or optical driver, or a floppy disk, and similar devices. Besides, some steps of functions of the present disclosure may be implemented by hardware, for example, a circuit cooperating with the processor to execute various functions or steps.

In addition, part of the present invention may be applied as a computer program product, e.g., a computer program instruction, which, when being executed by a computer, may invoke or provide a method and/or technical solution according to the present application through operation of the computer. The program instruction that invokes a method of the present application may be stored in a fixed or mobile recording medium, and/or transmitted through broadcast and/or a data flow in other signal carrier medium, and/or stored in a work memory running according to the program instruction in a computer device. Here, an embodiment according to the present application includes an apparatus that includes a memory for storing computer program instructions and a processor for executing program instructions, wherein when being executed by the processor, the computer program instruction triggers the apparatus to carry out the methods and/or technical solutions according to various embodiments of the present application.

To those skilled in the art, it is apparent that the present disclosure is not limited to the details of the above exemplary embodiments, and the present disclosure may be implemented with other forms without departing from the spirit or basic features of the present disclosure. Thus, in any way, the embodiments should be regarded as exemplary, not limitative; the scope of the present disclosure is limited by the appended claims, instead of the above depiction. Thus, all variations intended to fall into the meaning and scope of equivalent elements of the claims should be covered within the present disclosure. No reference signs in the claims should be regarded as limiting the involved claims. Besides, it is apparent that the term “comprise/comprising/include/including” does not exclude other units or steps, and singularity does not exclude plurality. A plurality of units or means stated in the apparatus claims may also be implemented by a single unit or means through software or hardware. Terms such as the first and the second are used to indicate names, but do not indicate any particular sequence.

1. A method, at a first user equipment, for operating a target application on a second user equipment corresponding to the first user equipment, wherein the method comprises:
receiving a desktop screenshot sent by the second user equipment, wherein the desktop screenshot includes application identification information of a target application displayed on the second user equipment's desktop;
displaying the desktop screenshot;
in response to a corresponding user's select operation on the application identification information in the desktop screenshot, converting coordinates of the application identification information on the first user equipment's screen into coordinates of the application identification information on the second user equipment's screen;
sending coordinates of the application identification information on the second user equipment's screen to the second user equipment;
receiving an application screenshot of the started target application sent by the second user equipment; and
displaying the application screenshot.

2. The method according to claim 1, wherein the method further comprises:
performing pre-processing on the desktop screenshot so as to obtain a desktop screenshot matching screen attributes of the first user equipment;
wherein displaying the desktop screenshot comprises:
displaying the pre-processed desktop screenshot.

3. The method according to claim 2, wherein the pre-processing comprises at least any one of the following:
performing adjustment processing on the desktop screenshot according to the first user equipment's screen size and the second user equipment's screen size;
performing adjustment processing on the desktop screenshot according to the first user equipment's aspect ratio and the second user equipment's aspect ratio.

4. The method according to claim 1, wherein the method further comprises:
obtaining an access operation executed by the user to a function module of the target application in the application screenshot;
in response to the access operation, converting coordinates of the function module on the first user equipment's screen into coordinates of the function module on the second user equipment's screen;
sending the coordinates of the function module on the second user equipment's screen to the second user equipment;
receiving a module screenshot of the started function module sent by the second user equipment; and
displaying the module screenshot.

5. The method according to claim 1, wherein the method further comprises:
sending the user's operation request regarding the target application in the second user equipment to the second user equipment.

6. A method, at a second user equipment, for assisting a first user equipment to operate a target application on the second user equipment, wherein the method comprises:
sending a desktop screenshot to a corresponding first user equipment, wherein the desktop screenshot includes application identification information of a target application displayed on the second user equipment's desktop;
receiving coordinates of the application identification information on the second user equipment's screen sent by the first user equipment;
performing a start application operation at the coordinates to start the target application;
sending an application screenshot of the started target application to the first user equipment.

7. The method according to claim 6, wherein the method further comprises:
receiving coordinates of a function module of the target application accessed by a corresponding user on the second user equipment's screen, sent by the first user equipment;
executing a module access operation at coordinates of the function module on the second user equipment's screen so as to start the function module; and
sending the module screenshot of the started function module to the first user equipment.

8. The method according to claim 6, wherein the method further comprises:
receiving a corresponding user's operation request regarding the target application in the second user equipment sent by the first user equipment;
wherein sending a desktop screenshot to a corresponding first user equipment comprises:
sending a desktop screenshot to a first user equipment in response to the operation request, wherein the desktop screenshot includes application identification information of the target application displayed on the second user equipment's desktop.

9. A first user equipment for operating a target application on a second user equipment, wherein the first user equipment comprises:
a unit configured to receive a desktop screenshot sent by the second user equipment, wherein the desktop screenshot includes application identification information of a target application displayed on the second user equipment's desktop;
a unit configured to display the desktop screenshot;
a unit configured to, in response to a corresponding user's select operation on the application identification information in the desktop screenshot, convert coordinates of the application identification information on the first user equipment's screen into coordinates of the application identification information on the second user equipment's screen;
a unit configured to send coordinates of the application identification information on the second user equipment's screen to the second user equipment;
a unit configured to receive an application screenshot of the started target application sent by the second user equipment; and
a unit configured to display the application screenshot.

10. The first user equipment according to claim 9, wherein the first user equipment further comprises:
a unit configured to perform pre-processing on the desktop screenshot so as to obtain a desktop screenshot matching screen attributes of the first user equipment;
wherein the unit configured to display the desktop screenshot is configured to:
display the pre-processed desktop screenshot.

11. The first user equipment according to claim 10, wherein the pre-processing comprises at least any one of the following:
performing adjustment processing on the desktop screenshot according to the first user equipment's screen size and the second user equipment's screen size;
performing adjustment processing on the desktop screenshot according to the first user equipment's aspect ratio and the second user equipment's aspect ratio.

12. The first user equipment according to claim 9, wherein the first user equipment further comprises:
a unit configured to obtain an access operation executed by the user to a function module of the target application in the application screenshot;
a unit configured to, in response to the access operation, convert coordinates of the function module on the first user equipment's screen into coordinates of the function module on the second user equipment's screen;
a unit configured to send the coordinates of the function module on the second user equipment's screen to the second user equipment;
a unit configured to receive a module screenshot of the started function module sent by the second user equipment; and
a unit configured to display the module screenshot.

13. The first user equipment according to claim 9, wherein the first user equipment further comprises:
a unit configured to send the user's operation request regarding the target application in the second user equipment to the second user equipment.

14. A second user equipment for assisting a first user equipment to operate a target application on the second user equipment, wherein the second user equipment, comprises:
a unit configured to send a desktop screenshot to a corresponding first user equipment, wherein the desktop screenshot includes application identification information of a target application displayed on the second user equipment's desktop;
a unit configured to receive coordinates of the application identification information on the second user equipment's screen sent by the first user equipment;
a unit configured to perform a start application operation at the coordinates to start the target application;
a unit configured to send an application screenshot of the started target application to the first user equipment.

15. The second user equipment according to claim 14, wherein the second user equipment further comprises:
a unit configured to receive coordinates of a function module of the target application accessed by a corresponding user on the second user equipment's screen, sent by the first user equipment;
a unit configured to execute a module access operation at coordinates of the function module on the second user equipment's screen so as to start the function module; and
a unit configured to send the module screenshot of the started function module to the first user equipment.

16. The second user equipment according to claim 14, wherein the second user equipment further comprises:
a unit configured to receive a corresponding user's operation request regarding the target application in the second user equipment sent by the first user equipment;
wherein the unit configured to send a desktop screenshot to a corresponding first user equipment is configured to:
send a desktop screenshot to a first user equipment in response to the operation request, wherein the desktop screenshot includes application identification information of the target application displayed on the second user equipment's desktop.

17. A system for operating a target application on a corresponding device, wherein the system comprises a first user equipment according to claim 9 and a second user equipment according to claim 14.

18. A computer-readable storage medium, which comprises computer instructions, when the computer instructions are executed, the method of claim 1 is performed.

19. A computer program product, when the computer program product is executed, the method of claim 1 is performed.

20. A computer device, which comprises a memory and a processor, the memory stores computer codes, the processor is configured to execute a method according to claim 1 by executing the computer codes.
